(19) United States
(12) Patent Application Publication
(10) Pub. No.: US 2006/0050605 A1
(43) Pub. Date: Mar. 9, 2006

(54) High-power sono-chemical reactor

(75) Inventor: Evgeny Markhasin, Migdal Ha'Emek (IL)

Correspondence Address: DR. MARK FRIEDMAN LTD.;C/o Bill Polkinghorn, 9003 Florin Way, Upper Marlboro, MD, 20772, US

(73) Assignee: Nano-Em Ltd.

(21) Appl. No.: 11/126,172

(22) Filed: May 11, 2005

Related U.S. Application Data
(60) Provisional application No. 60/607,591, filed on Sep. 8, 2004.

(51) Int. Cl. B01F 11/00

(52) U.S. Cl. 366/116

(57) ABSTRACT

A device and method for sono-chemical processing, including a reactor bounded by a substantially cylindrical wall, the reactor having: a reaction volume, defined by the wall; first and second magnetostrictors, associated with the reaction volume, the wall and the magnetostrictors designed and disposed such that the first magnetostrictor produces a first series of ultrasonic waves having a first frequency within the reaction volume, the second magnetostrictor produces a second series of ultrasonic waves having a second frequency within the reaction volume, wherein the second frequency exceeds the first frequency.

This application draws priority from U.S. Provisional Patent Application Ser. No. 60/607,591, filed 8 Sep., 2004.

### FIELD AND BACKGROUND OF THE INVENTION

The present invention relates to a method and device for effecting and enhancing chemical reactions and processes, and more particularly, to a method and device for producing water-and-hydrocarbon nano-emulsions.

Emulsions containing water and diesel oil have drawn much interest as being ecologically clean fuels.

The emulsification of two such immiscible liquids involves thermodynamically treating the liquids so as to destroy the cohesive forces within a liquid, so as to form extremely small droplets.

The most efficient method to produce nano-emulsions involves achieving cavitation within the liquids to be emulsified. Cavitation is a well-known effect wherein, due to disruption of cohesive forces by an external mechanical action upon a liquid, bubbles are formed, which are immediately filled with gases that have been dissolved in the liquid, or with the vapor form of the liquid itself. Cavitation usually occurs in pipes carrying water, ship propellers operating at high RPM, centrifugal pumps pumping liquids, high-speed mixer blades, and similar devices.

The emulsification of two immiscible liquids into nano-emulsions is best achieved in a reactor that is operationally connected to a transducer for obtaining electromagnetic high-frequency energy and converting it into mechanical oscillation (ultrasound). The generated ultrasound is radiated into the cavity of a reactor, thereby producing cavitation.

All prior-art ultrasound processors utilize a considerable number of low-power, piezo-ceramic transducers glued onto the exterior walls of cylindrical reactors. This construction has an adverse effect of attenuating useful transmissions of high-intensity ultrasound energy. Moreover, the piezo-ceramic generators transmit low-energy ultrasound through the walls of the reactor, causing a considerable energy loss. Furthermore, the cavitation bubbles generated on the walls of the reactor cause an additional loss in ultrasound energy, as the gas bubbles absorb the ultrasound. Because of these shortcomings, the efficiency of the above reactors is considerably low, never achieving more than 25-30%.

Because of the low useful energy generated by the ultrasound reactors of the prior art (e.g., the reactor disclosed in WO 97/02088 PCT), the emulsion production rates of such reactors are correspondingly low. Moreover, the average size of the droplets is several microns.

To increase productivity, U.S. Pat. No. 5,384,508 teaches a tube that at every half-wavelength distance has a resonating ring whose average diameter equals the wavelength of the radiated ultrasound. Each of the rings is connected to a low-power, piezo-ceramic transducer. The length of the tube is optimized to the time necessary to process the material flowing through the tube.

Each ring on the tube concentrates the ultrasound within a region associated with the ring. This arrangement, however, precludes the process from achieving high production rates, because most of the useful energy is absorbed by the considerable mass of the ring. Furthermore, the remaining useful energy is diminished by a sonotrode construction having poor acoustic properties. The shortcomings of the construction are further exacerbated by the high-amplitude oscillations, which cause material fatigue of the rings. Additionally, since the diameter of a ring is dictated by the wavelength of the ultrasound, it becomes technically impossible for a transducer having a power rating of 200-400 kW (the power rating cannot exceed 1 kW due to the accelerated fatigue of the construction materials) to be connected to a ring whose diameter is about 30 mm for operating at a frequency of 20 kHz. This narrow diameter further limits raw material flowrate, and, consequently, productivity. Therefore, the sonotrode construction employing such tubes and rings is useful only for processing materials that do not require generation of high-intensity ultrasound.

U.S. Pat. No. 5,658,534 teaches an ultrasound processor having a tube of stainless steel that is 2.5 mm thick, and is connected to three equidistant transducers providing ultrasound having a power distribution of 0.3-1.0 W/cm².

The goal of the above construction is to create, within a material flow, a region of concentrated energy. This effect of energy concentration is sufficient to impart the reactor with a relatively high specific power.

The above reactor, however, is complicated and expensive to build, demanding that transducers are strictly synchronized in phase. Moreover, the relatively small size of the concentrated energy region does not allow for emulsification or homogenization of materials in a continuous mode on an industrial scale.

A standard homogenizer/emulsifier technology capable of processing materials in continuous mode utilizes a cell technology. This technology achieves characteristically low throughputs. For example, when emulsifying lipophilic materials having equal molecular weights, such cells are limited to a maximal flow rate of 5 liters/hour.

Another commercially-available homogenizer, distributed by Cole-Palmer Ltd., has twelve transducers rated at 0.75 kW/hour that are capable of producing a combined 9 kW/hour ultrasound during a continuous production mode. The design utilizes standard sonotrodes, from which it follows that the design suffers from low production efficiency and from a high rate of erosion of the waveguides. Tests performed by the inventor show that this homogenizer fails to produce emulsions having a sufficiently low droplet size. Moreover, the design requires an unusually large reactor, because the twelve low-efficiency sonotrodes discharge a copious quantity of heat, thereby creating the need for an extremely large cooling system.

It is evident from all of the above that the above-described prior art is fundamentally incapable of providing the high specific-energy required for industrial production of nano-emulsions, due, inter alia, to poor sonotrode efficiency. The reactors disclosed by the prior art also require frequent maintenance of the ultrasound-generating equipment due to rapid erosion thereof.

Several reactor configurations have been used to produce nano-emulsions. U.S. Pat. No. 6,079,508 to Caza and U.S. Pat. No. 5,658,534 to Desborough teach reactors having a plurality of ultrasonic transducers placed around the reactor enclosure. The disparity of the longitudinal and the transversal dimensions of the reactor causes the ultrasonic energy to be distributed in a non-homogenous pattern, thereby decreasing the volume available for useful cavitation, and ultimately leading to a low product throughput.

There is therefore a recognized need for, and it would be highly advantageous to have a method and device for producing nano-emulsions that achieves a higher yield and allows for a substantially higher production rate than methods known heretofore. It would be of further advantage if such a reactor would be simple in construction and would allow for continuous production of such nano-emulsions.

### SUMMARY OF THE INVENTION

According to the teachings of the present invention there is provided a device for sono-chemical processing, including a reactor bounded by a substantially cylindrical wall, the reactor having: (a) a reaction volume, defined by the wall; (b) a first magnetostrictor, associated with the reaction volume, and (c) a second magnetostrictor, associated with the reaction volume, the wall and the first magnetostrictor designed and disposed such that the first magnetostrictor produces a first series of ultrasonic waves having a first frequency within the reaction volume, the wall and the second magnetostrictor designed and disposed such that the second magnetostrictor produces a second series of ultrasonic waves having a second frequency within the reaction volume, wherein the second frequency exceeds the first frequency.

According to further features in the described preferred embodiments, the first frequency and the second frequency are selected so as to achieve modulation between the first series of ultrasonic waves and the second series of ultrasonic waves.

According to still further features in the described preferred embodiments, the reaction volume is for containing at least two immiscible fluids, and wherein the first magnetostrictor and the second magnetostrictor are disposed with respect to the wall, such that upon introduction of the fluids into the reaction volume, the first series of ultrasonic waves and the second series of ultrasonic waves act upon the fluids so as to produce a nano-emulsion.

According to still further features in the described preferred embodiments, the second magnetostrictor is disposed below the reaction volume.

According to still further features in the described preferred embodiments, the second magnetostrictor includes a wave guide, the wave guide being disposed in the wall, adjacent to a bottom surface of the reaction volume, the wave guide for directing the second series of ultrasonic waves into the reaction volume.

According to still further features in the described preferred embodiments, the first frequency is in a range of 2 kHz, inclusive, to 10 kHz, inclusive.

According to still further features in the described preferred embodiments, the first frequency is in a range of 2 kHz, inclusive, to 8.5 kHz, inclusive.

According to still further features in the described preferred embodiments, the second frequency is in a range of 18 kHz, inclusive, to 40 kHz, inclusive.

According to still further features in the described preferred embodiments, the second frequency is in a range of 18 kHz, inclusive, to 40 kHz, inclusive.

According to still further features in the described preferred embodiments, the ratio of the first frequency to the second frequency is less than 1:2, inclusive.

According to still further features in the described preferred embodiments, the ratio of the first frequency to the second frequency is in a range of 1:2, inclusive, to 1:10, inclusive.

According to still further features in the described preferred embodiments, the first magnetostrictor is disposed so as to radiate the first series of ultrasonic waves radially inward into the reaction volume, thereby producing cavitation along a longitudinal axis of the reaction volume.

According to still further features in the described preferred embodiments, the second magnetostrictor and the wave guide are disposed so as to focus the second series of ultrasonic waves towards a longitudinal axis of the reaction volume.

According to still further features in the described preferred embodiments, the device further includes a flexible pad or gasket, disposed between the first and second magnetostrictors, for hermetically sealing between the wave guide and the reaction volume, and for enabling acoustical communication between the first and second magnetostrictors.

According to still further features in the described preferred embodiments, the inside diameter of the flexible gasket is smaller than an inside diameter of a cylindrical portion of the wave guide.

According to still further features in the described preferred embodiments, the inside diameter of the flexible gasket is smaller than the inside diameter of the cylindrical portion of the wave guide by at least 0.2 mm.

According to another aspect of the present invention, there is provided a method of sono-chemical processing including the steps of: (a) providing a reactor bounded by a substantially cylindrical wall, the reactor having: (i) a reaction volume, defined by the wall; (ii) a first magnetostrictor, associated with the reaction volume, and (iii) a second magnetostrictor, associated with the reaction volume; (b) activating the first magnetostrictor to produce a first series of ultrasonic waves having a first frequency within the reaction volume, and (c) activating the second magnetostrictor to produce a second series of ultrasonic waves having a second frequency within the reaction volume, wherein the second frequency exceeds the first frequency.

According to further features in the described preferred embodiments, the method further includes the steps of: (d) introducing a first fluid into the reaction volume, and (e) introducing a second fluid into the reaction volume, the second fluid being substantially immiscible with the first fluid, wherein the first frequency and the second frequency are selected such that the first and second series of ultrasonic waves produce a nano-emulsion of the fluids.

According to still further features in the described preferred embodiments, the method further includes the step of: (f) selecting the first frequency and the second frequency so as to achieve modulation between the first series of ultrasonic waves and the second series of ultrasonic waves.

According to still further features in the described preferred embodiments, the method further includes the step of: disposing the second magnetostrictor below the reaction volume.

According to still further features in the described preferred embodiments, the method further includes the step of: withdrawing the nano-emulsion as a continuous process.

According to still further features in the described preferred embodiments, the method further includes the step of: producing the nano-emulsion as a batch process.

According to still further features in the described preferred embodiments, the activating of the magnetostrictors is performed to produce an acoustical pressure of at least 1 kg per square centimeter in the reaction volume.

According to still further features in the described preferred embodiments, the acoustical pressure is within a range of 1 kg per square centimeter to 4 kg per square centimeter.

According to still further features in the described preferred embodiments, the activating of the magnetostrictors is performed to effect, within the reaction volume, a specific energy of 1.4-4.2 W/cm3, so as to efficiently produce the nano-emulsion.

According to still further features in the described preferred embodiments, the first fluid includes water and wherein the second fluid includes a hydrocarbon.

According to still further features in the described preferred embodiments, the second fluid is primarily diesel fuel.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a cross-sectional view of a reactor according to one embodiment of the present invention;

FIG. 2 is a magnified view of a portion of the reactor in FIG. 1, showing a linear transducer and a sonotrode attached thereto;

FIG. 3 is a top view of the reactor of FIG. 1;

FIG. 3A is a side, cross-sectional view of the reactor cover;

FIG. 4A is a conceptual diagram of a system for producing nano-emulsions, the system including the inventive reactor;

FIG. 4B is a conceptual diagram of a system for producing nano-emulsions, the system including the inventive reactor and a homogenizing bath, and

FIG. 5 is a graphical representation of A_{mod} as a function of time.

### DESCRIPTION OF THE PREFERRED EMBODIMENTS

The principles and operation of the reactor according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

As used herein in the specification and in the claims section that follows, the term “transducer” refers to a device that converts input electromagnetic or electrical energy into output energy in the form of ultrasound.

As used herein in the specification and in the claims section that follows, the term “magnetostrictor” refers to a device that transforms high-frequency current into ultrasound.

Emulsions composed of fuel and water are known to be difficult to produce and extremely unstable. Since the stability of emulsion improves with decreasing droplet size, production methods should preferably be directed towards producing emulsions of the smallest possible droplet size, while maintaining a high rate of production.

The cavitation effect of ultrasound has been used in the production of emulsions. To maximize the eroding property of the cavitation, an additional effect of external hydrostatic pressure can be used. This effect substantially increases the energy of the cumulative jet action of the collapsing bubbles produced by cavitation. However, hydrostatic pressure can inhibit the much-desired bubble generation, decrease cavitation, and reduce the number of bubbles per unit of volume. High hydrostatic pressures can suppress the cavitation altogether.

The use of hydrostatic pressure has been known to cause low emulsion yields in continuous production methods, therefore, it has been used only in batch production. It would be highly advantageous to achieve, in a continuous process, the increased erosion associated with external hydrostatic pressure in batch processes.

When comparing characteristics of low and high frequencies of same power level, low frequencies, being inherently high in amplitude, produce high acoustical pressure, thereby creating large bubbles that are undesirable in the production of nano-emulsions. High frequencies, on the other hand, produce lower acoustical pressure and advantageously produce small bubbles. However, high-frequency ultrasonic waves are inherently low in amplitude and create droplets that have a distinct tendency to collapse.

In the present invention, it has been surprisingly discovered that the most favorable form of ultrasound cavitation for producing nano-emulsions is created by adding the two frequencies, such that the ultrasonic waves characterized by each of the two frequencies are superimposed. Preferably, the first frequency and said second frequency are selected so as to achieve modulation between said first series of ultrasonic waves and said second series of ultrasonic waves.

Without wishing to be limited by theory, it is believed that the beneficial effect is achieved by the high-amplitude, low frequency waves dividing the reactor volume into a multitude of minor regions, each oscillating at a high frequency. Thus, the high acoustical pressure replaces the effect of, and obviates the need for, an external hydrostatic pressure acting on the small bubbles formed by the high-frequency waves.

The current invention also relates to a new type of high-power sonic processor that utilizes ultrasound cavitation generated by radiating two ultrasound frequencies at an optimal ratio between 1:2 and 1:10.

Preferably, the range for the lower frequency is 2-10 kHz, and more preferably, 2-8.5 kHz. The range for the higher frequency is 18-40 kHz.

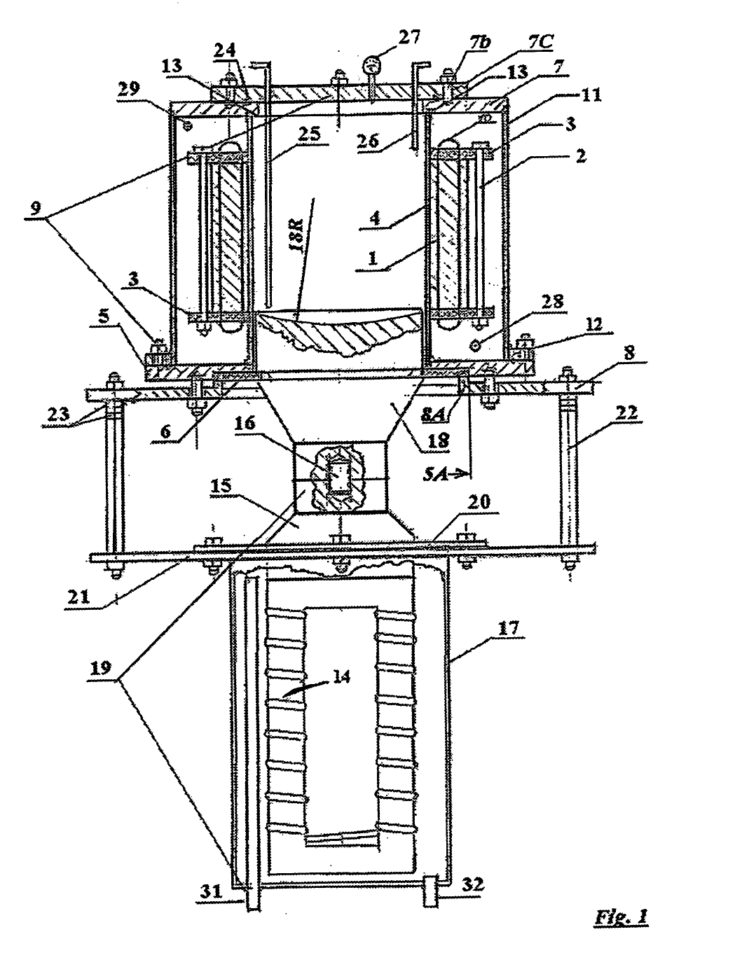

As shown in FIG. 1, one inventive feature of reactor 108 is the incorporation of a linear transducer and an axial transducer. The axial transducer contains a cylindrical (or axial) magnetostrictor 1, which includes a stack of ring plates. The ring plates have a thickness of 0.1-0.2 mm and are made of magnetostrictive materials preferably having an inwardly-directed stricture. One such material is nickel.

One of the advantages of using nickel is that an oxidation layer, Ni₂O₃, formed either thermally or, preferably, by acid treatment, is an excellent insulator. This property allows the magnetostrictor to be stacked between fiberglass flanges 3, and compressed by compression bolts 2.

The stacked construction of the magnetostrictor drastically decreases energy loss and increases heat conduction when compared to magnetostrictors constructed of plates that have been glued with Bakelite™ or organosilicon glues.

Thus, during the assembly of the magnetostrictor, the plates are stacked according to a predetermined shape, and the inner diameter of the formed cylindrical stack is polished. Upon being thermally expanded, the stack is subsequently swaged on to a tube, or a cylinder (cylindrical wall) 4, preferably manufactured of an ASTM 316SL stainless steel and having a thickness of preferably 2 to 3 mm.

The optimal thickness of cylinder 4 has been found to be 3 mm, which is necessary for a reliable weld of the cylinder to flanges 3, thereby ensuring strength required to resist the destructive forces of high-amplitude ultrasound oscillations while containing the oscillations within the cavity of cylinder 4 with minimal loss.

The lower end of cylinder 4 is welded to a support flange 5, which has an approximate thickness of about 10 mm and is manufactured of ASTM 306 or ASTM 316 stainless steel. Flange 5 has a diameter 5A that is 20 mm larger than the inner diameter of flange 5. Diameter 5A serves to admit an external section of sealing gasket 6, which seals the lower end of the ultrasonic chamber defined by flange 5 and an upper plate 7. Gasket 6 is preferably manufactured from a hexafluoropropylene-vinylidene fluoride co-polymer (such as Viton®). Gasket 6 forms a seal between flange 5 and a lip 8A of a mounting ring 8, which serves as a structural mount of a reactor 9.

Axial magnetostrictor 1 has a coil 10 inserted through openings in magnetostrictor plates. The windings of coil 10 are perpendicular to the plates, i.e., parallel to the wall of cylinder 4. Electrical contacts to the wiring of coil 10 are contained in a hermetically sealed outlet (not shown) located on the external surface of a cooling jacket 11 of magnetostrictor 1. The wire insulation material is polytetrafluoroethylene (Teflon®), or any other similar material.

Cooling jacket 11 is attached by a bolt 12 to flange 5. A polytetrafluoroethylene gasket 13 can be tightened to form a seal between plate 7 and cylinder 4. Gasket 13 also serves as an electrical insulator that disrupts the circuit formed by cylinder 4 and cooling jacket 11, thereby preventing induction of any undesirable currents in the reactor housing.

The height and volume of the reactor are determined by the desired power rating, which is also equivalent to the magnetostrictor inductivity, and to magnetostrictor resonance at the low frequency mode of operation.

The high-frequency ultrasound is generated by a magnetostrictor 14, which is a linear magnetostrictive transducer. Preferably, the ultrasonic waves have a frequency in the range of 18 to 40 kHz. More preferably, the frequency is in the range of 18 to 30 kHz, and most preferably, the frequency is in the range of 20 to 25 kHz. Magnetostrictor 14 has a rectangular cross section, and is soldered by silver or titanium to sound transformer 15 (preferably made of a Ti-4V-6Al titanium alloy). Sound transformer 15 has a M20 metric threaded opening, which accepts a joining pin 16 of matching thread. Magnetostrictor 14 with corresponding coil windings is contained within a casing 17, which also serves as a cooling jacket.

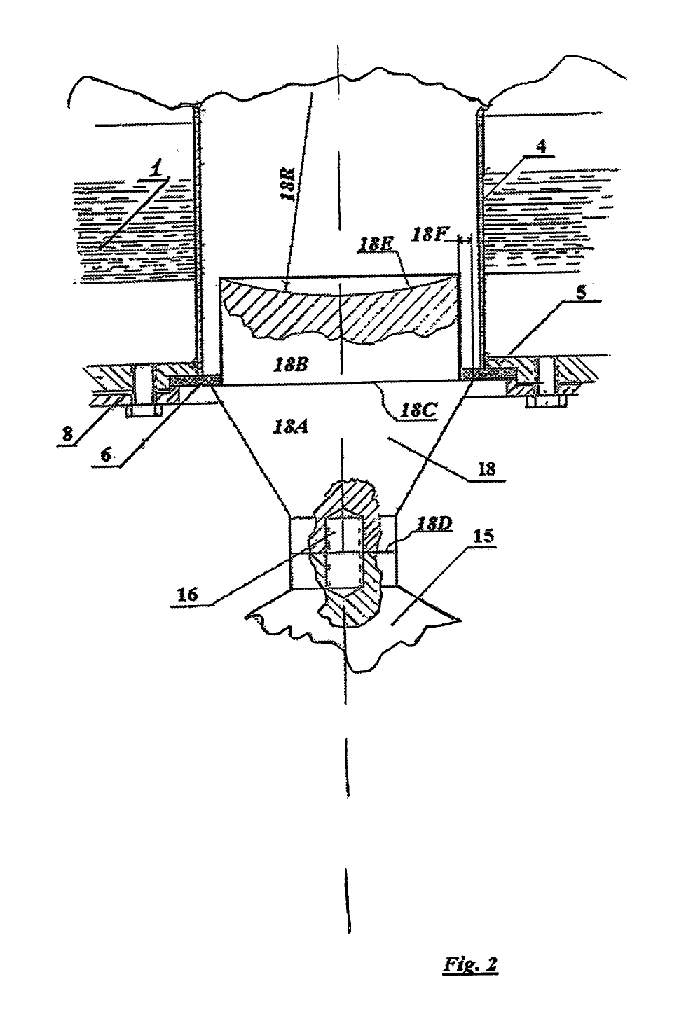

Another inventive feature of the invention is a sonotrode, or wave guide, having an innovative structure. Referring now to FIG. 2, the structure of sonotrode 18 is dictated by acoustical and design requirements. Sonotrode 18, in addition to being the source of high-frequency ultrasound, also serves as the bottom part of the reactor, which ensures a hermetical closure of the working cavity of the reactor.

Sonotrode 18 has a conical lower section 18A, whose surface 18D matches an upper surface of sound transformer 15. In surface 18D, there is an opening containing threaded pin 16, which joins sound transformer 15 to sonotrode 18. Surface 18D and the matching sound transformer surface are substantially perfectly planar and highly polished.

An upper section 18B of sonotrode 18 is a cylinder whose base is disposed at the point of null amplitude, i.e., at the node of ultrasound waves radiated into the cavity of the reactor. The diameter of section 18B is approximately 10 mm smaller than the diameter of a surface 18C, thereby forming a ledge that seats gasket 6, of thickness between 3-5 mm. The inner diameter of gasket 6 is 0.2 mm smaller than the diameter of section 18B so as to achieve a tight fit as it seats on lip 8A, thereby assuring a hermetically tight seal. The 0.2 mm difference in diameter also allows insulation of the inner diameter of the gasket and the cylindrical part of sonotrode 18 from the erosive action of cavitation bubbles.

The outer diameter of gasket 6 matches a recessed diameter of flange 5, thereby assuring that sonotrode 18 is perfectly centered relative to axial magnetostrictor 1. Mounting ring 8 presses gasket 6 into place, thereby preventing any unwanted contact between the metal of sonotrode 18 and the inner surface of cylinder 4. Gasket 6 also serves to provide a flexible, cushioning joint between the sonotrodes, thus enabling vertical vibrations to pass between the two sonotrodes and establishing an acoustical coupling therebetween.

Section 18B contains a concave radiating surface 18E having a radius 18R, calculated to enable sonotrode 18 to radiate continuous acoustical currents, to prevent the surface from being eroded by cavitation, and to optimize transmission of ultrasound into the reactor cavity. Sonotrode 18 is preferably made of a Ti-4V-6Al titanium alloy (or a similar alloy) or of ASTM 316SL stainless steel (or a similar alloy), both of which possess excellent resonance properties.

When utilizing raw materials which are suspensions and powders, section 18B is provided with a circumferential ledge characterized by the difference of diameters 18F for accommodating a ring of Viton® rubber to keep particles from entering the weak oscillation region, located between cylindrical surface of sonotrode 18 and cylinder 4, and to prevent the region from being blocked by powder aggregates.

A casing 19 is mounted on a support plate 21 that is fixed to ring 8 by struts 22. The length of struts 22 equals the length of conical lower section 18A. The upper ends of struts 22 have adjustable rubber adaptors 23, allowing for centering the reactor relative to the linear transducer.

Upper plate 7 of cooling jacket 11 has threaded pins 7B and a seat for accommodating a rubber gasket 24. A reactor cover 7C is mounted by means of by pins 7B and rubber seal 24.

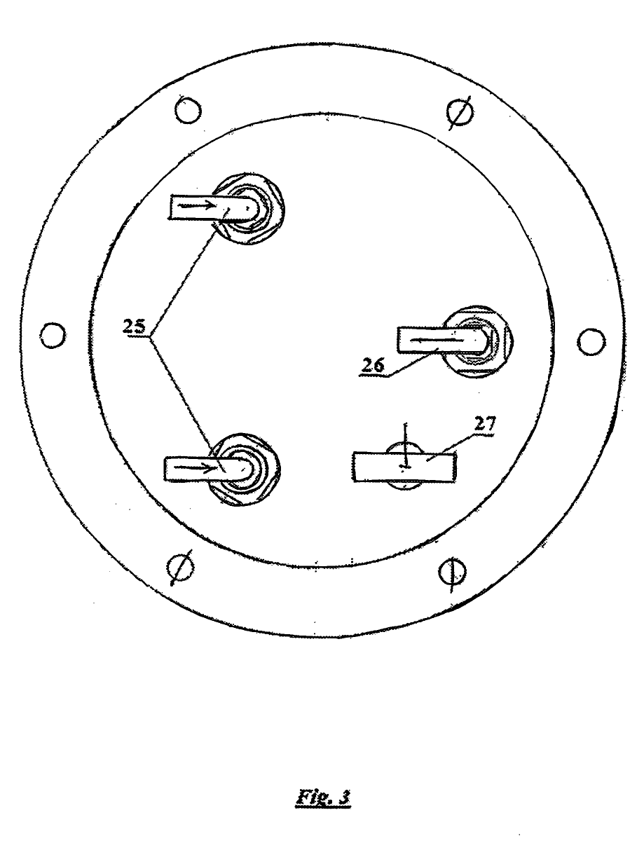

Reactor cover 7C has seals 32, through which are mounted two intake tubes 25 and an output tube 26, as shown in FIG. 3A. The tubes have an inner diameter of 8 mm and an outer diameter of preferably about 10 mm, which has been determined to equal the width of the cavitation-free region in the cylindrical transducer, thus preventing cavitation that would erode the tube material. Furthermore, this diameter creates diffraction of ultrasound waves at the openings of the tubes which does not distort the focus of the ultrasound waves nor interferes with the conductance of the waves from the walls of the reactor inwards to the center thereof. The above tubes enter reactor cover 7C at radially-disposed points, as shown in FIG. 3, allowing the tubes to enter cavitation-free regions within the reactor cavity, and approximately 15 mm from the wall of cylinder 4.

Output tube 26 has an orifice whose diameter is four times smaller than the total square area of the cross-sections of intake tubes 25. This specific criterion assures a backpressure of approximately 1.5 to 2.5 atmospheres at a raw material delivery rate of 8 to 12 liters per minute. This pressure substantially increases the erosive property of ultrasound, which is beneficial to the dual-frequency ultrasound production of emulsions, suspensions, and similar materials. Reactor cover 7C is preferably equipped with a sleeve for mounting a manometer 27.

The cooling of magnetostrictors 1, 14 is accomplished by externally-supplied water controlled to flow at a flow rate of approximately 3 liters per minute, and at a temperature below 15 degrees C. The cooling can be also accomplished by a pump-driven recirculating system.

Cooling jackets 11 and 17 are connected in series, wherein, as illustrated in FIG. 1, water from discharge tube 30 of jacket 17 enters inlet 28 on jacket 11. Spent water exits discharge tube 29 to return to the recirculating system. The above-mentioned serial connection of cooling jackets is based on the principle of superimposing waves having different wavelengths. This effect divides the reactor volume into mobile regions, or domains, each having specifically modulated high frequencies at the center and specifically modulated low frequencies at the boundary. This effect successfully avoids the creation of undesirable low frequencies at the outer regions of the reaction volume.

The outer boundary of each such region consists of low-frequency waves that have a significantly higher amplitude than the high-frequency waves inside the mobile domains, and, therefore, a significantly-higher acoustical pressure. Acoustical pressure of consistent frequency has the same beneficial effect as external hydrostatic pressure in increasing the energy of cumulative jets that are constantly being created by the collapsing of the cavitation bubbles. The effect of high frequency waves is instrumental in causing the bubbles to collapse, thereby increasing the cavitation effect as well as the number of cavitation loci.

Assuming the following definitions for the two (higher-frequency and lower-frequency) wave functions:
t=time;
xᵢ=displacement of an individual wave function, xᵢ=xᵢ(t);
x=total displacement, x=x₁+x₂;
A=amplitude;
ω=angular frequency;
ωₐᵥ=average angular frequency, ωₐᵥ=½·(ω₁+ω₂);
ω_{mod}=modulation angular frequency, ω_{mod}=½·(ω₁−ω₂), and
φ=oscillation initial frequency,
then if A₁=A₂=A; φ₁=φ₂=0, and ω₁≠ω₂,
   x₁=A₁·sin ω₁t
   x₂=A₂·sin ω₂t
   The total displacement, x, is equal to x₁+x₂=A(sin ω₁t−sin ω₂t). Solving, we obtain:
   x=2A cos[(ω₁−ω₂)t/2]·sin[(ω₁−ω₂)t/2].
   Since x=x₁+x₂=A_{mod}(t)·sin ωₐᵥt, we obtain:
   A_{mod}(t)=2A cos ω_{mod}t.

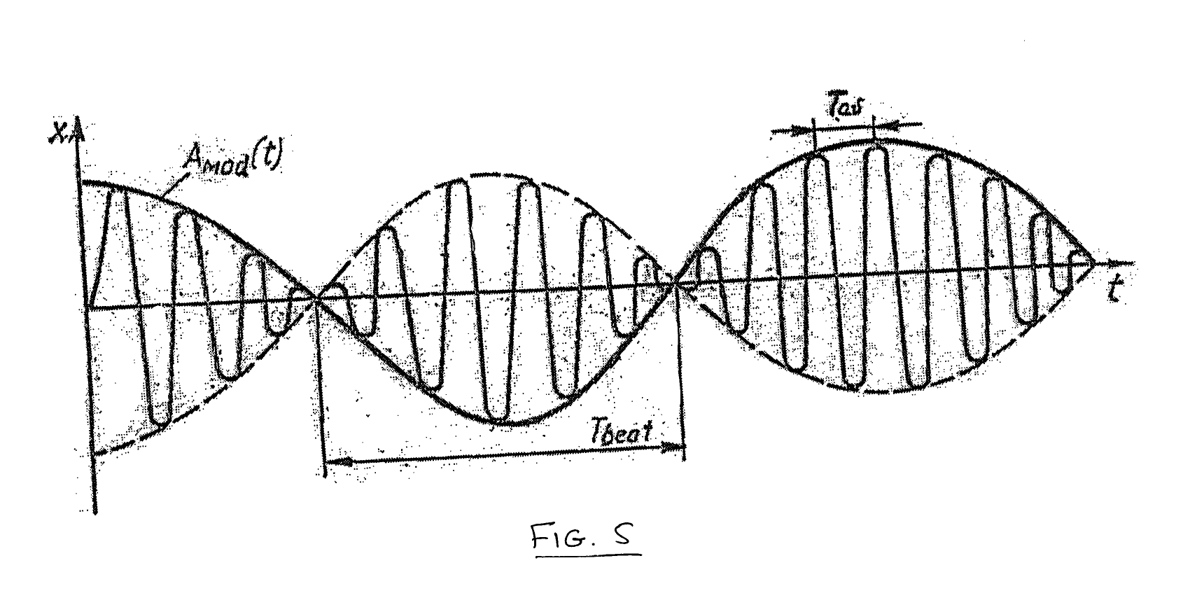

The function A_{mod} is shown graphically in FIG. 5, as a function of time. Also shown are Tₐᵥ and T_{beat}, defined by:
Tₐᵥ is the oscillation period with ωₐᵥ, and
   T_{beat} is the half-period of the amplitude variation.

As used herein in the specification and in the claims section that follows, the term “modulation” and the like, refers to a wave function having properties substantially as defined by the equation, A_{mod}(t)=2A cos ω_{mod}t, as developed hereinabove.

The dual ultrasound frequency produced by the reactor of the present invention is manifested by the considerably higher erosive—and therefore, more productive—capabilities of the ultrasound processor with respect to reactors of the prior art. The effect has been tested in a production of diesel-water emulsion having droplets whose mean particle size is between 70-300 nm. The two-frequency reactor provides for nano-emulsion production rates of at least 5 liters per minute.

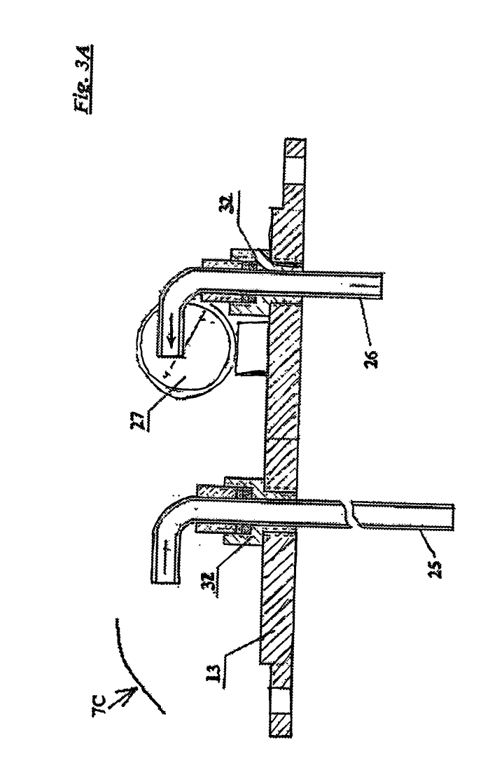

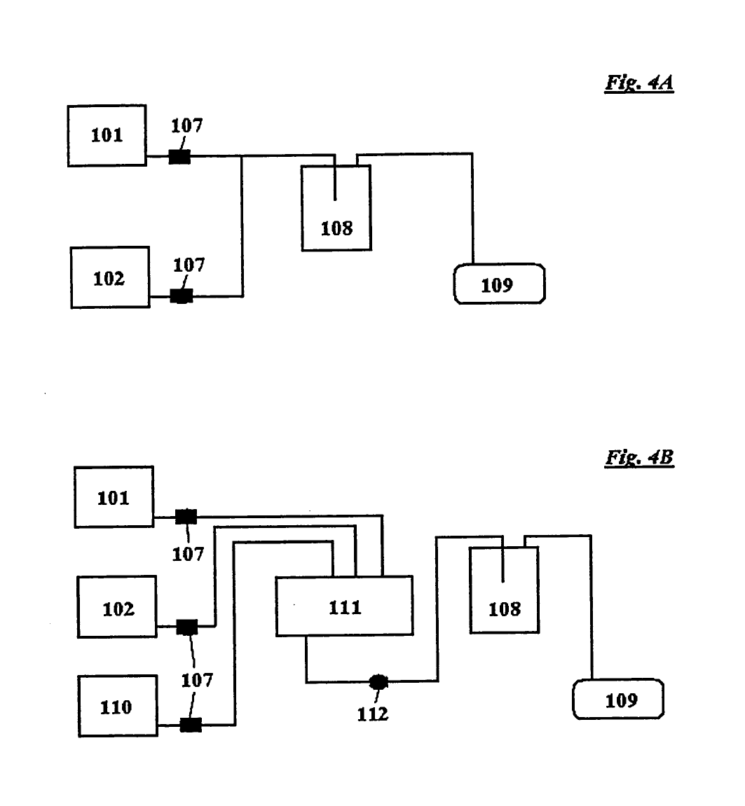

According to another aspect of the present invention, the fuel-water emulsion is preferably manufactured by using the reactor of the present invention in a system schematically illustrated in FIG. 4A. Water from a tank 101 and diesel from a tank 102 are pumped by metering pumps 107 directly to an ultrasonic reactor 108, which has been illustrated in detail in FIG. 1. Ultrasonic waves of differing frequencies are applied to the diesel-water, as described hereinabove. The nano-emulsion produced in reactor 108 is stored in storage tank 109.

In another embodiment of the invention, the fuel-water emulsion is manufactured by using the reactor of the present invention in a system schematically illustrated in FIG. 4B. Water and water-additives are stored in tank 101. A mixture of diesel fuel and oil-soluble additives are stored in tank 102. Diesel oil is stored in tank 110. Pumps 107 deliver contents of the tanks to an ultrasonic bath 111, where the fluids mix into a homogenized mixture. The mixture is transferred by pump 112 to reactor 108. Ultrasonic waves of differing frequencies are applied to the diesel-water, as described hereinabove. The nano-emulsion produced in reactor 108 is stored in storage tank 109.

The processes in the above embodiments can be carried out either in batch mode, semi-batch mode, semi-continuous mode, or in continuous mode.

The diesel fuel and/or the water preferably contain at least one surfactant. Surfactants of particular suitability for use in conjunction with the nano-emulsion device and method of the present invention have been described in our co-pending U.S. Patent Application Ser. No. 60/607,591, which is incorporated by reference for all purposes as if fully set forth herein.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, no citation or identification of any reference in this application shall be construed as an admission that such reference is available as prior art to the present invention.

What is claimed is:

1. A device for sono-chemical processing, the device comprising:
a reactor bounded by a substantially cylindrical wall, said reactor having:
(a) a reaction volume, defined by said wall;
(b) a first magnetostrictor, associated with said reaction volume, and
(c) a second magnetostrictor, associated with said reaction volume,
said wall and said first magnetostrictor designed and disposed such that said first magnetostrictor produces a first series of ultrasonic waves having a first frequency within said reaction volume,
said wall and said second magnetostrictor designed and disposed such that said second magnetostrictor produces a second series of ultrasonic waves having a second frequency within said reaction volume,
wherein said second frequency exceeds said first frequency.

2. The device of claim 1, wherein said first frequency and said second frequency are selected so as to achieve modulation between said first series of ultrasonic waves and said second series of ultrasonic waves.

3. The device of claim 1, wherein said reaction volume is for containing at least two immiscible fluids, and wherein said first magnetostrictor and said second magnetostrictor are disposed with respect to said wall, such that upon introduction of said fluids into said reaction volume, said first series of ultrasonic waves and said second series of ultrasonic waves act upon said fluids so as to produce a nano-emulsion.

4. The device of claim 1, wherein said second magnetostrictor is disposed below said reaction volume.

5. The device of claim 4, wherein said second magnetostrictor includes a wave guide, said wave guide being disposed in said wall, adjacent to a bottom surface of said reaction volume, said wave guide for directing said second series of ultrasonic waves into said reaction volume.

6. The device of claim 1, wherein said first frequency is in a range of 2 kHz, inclusive, to 10 kHz, inclusive.

7. The device of claim 1, wherein said first frequency is in a range of 2 kHz, inclusive, to 8.5 kHz, inclusive.

8. The device of claim 1, wherein said second frequency is in a range of 18 kHz, inclusive, to 40 kHz, inclusive.

9. The device of claim 6, wherein said second frequency is in a range of 18 kHz, inclusive, to 40 kHz, inclusive.

10. The device of claim 1, wherein a ratio of said first frequency to said second frequency is less than 1:2, inclusive.

11. The device of claim 1, wherein a ratio of said first frequency to said second frequency is in a range of 1:2, inclusive, to 1:10, inclusive.

12. The device of claim 1, wherein said first magnetostrictor is disposed so as to radiate said first series of ultrasonic waves radially inward into said reaction volume, thereby producing cavitation along a longitudinal axis of said reaction volume.

13. The device of claim 5, wherein said second magnetostrictor and said wave guide are disposed so as to focus said second series of ultrasonic waves towards a longitudinal axis of said reaction volume.

14. The device of claim 5, further comprising a flexible gasket, disposed between said first and second magnetostrictors, for hermetically sealing between said wave guide and said reaction volume, and for enabling acoustical communication between said first and second magnetostrictors.

15. The device of claim 14, wherein an inside diameter of said flexible gasket is smaller than an inside diameter of a cylindrical portion of said wave guide.

16. The device of claim 15, wherein said inside diameter of said flexible gasket is smaller than said inside diameter of said cylindrical portion of said wave guide by at least 0.2 mm.

17. A method of sono-chemical processing, comprising the steps of:
(a) providing a reactor bounded by a substantially cylindrical wall, said reactor having:
(i) a reaction volume, defined by said wall;
(ii) a first magnetostrictor, associated with said reaction volume, and
(iii) a second magnetostrictor, associated with said reaction volume;
(b) activating said first magnetostrictor to produce a first series of ultrasonic waves having a first frequency within said reaction volume, and
(c) activating said second magnetostrictor to produce a second series of ultrasonic waves having a second frequency within said reaction volume,
wherein said second frequency exceeds said first frequency.

18. The method of claim 17, further comprising the steps of:
(d) introducing a first fluid into said reaction volume, and
(e) introducing a second fluid into said reaction volume, said second fluid being substantially immiscible with said first fluid,
wherein said first frequency and said second frequency are selected such that said first and second series of ultrasonic waves produce a nano-emulsion of said fluids.

19. The method of claim 18, further comprising the step of:
(f) selecting said first frequency and said second frequency so as to achieve modulation between said first series of ultrasonic waves and said second series of ultrasonic waves.

20. The method of claim 17, further comprising the step of:
(d) disposing said second magnetostrictor below said reaction volume.

21. The method of claim 18, wherein said first frequency is in a range of 2 kHz, inclusive, to 10 kHz, inclusive.

22. The method of claim 18, said second frequency is in a range of 18 kHz, inclusive, to 40 kHz, inclusive.

23. The method of claim 18, wherein a ratio of said first frequency to said second frequency is in a range of 1:2, inclusive, to 1:10, inclusive.

24. The method of claim 18, further comprising the step of:
(f) withdrawing said nano-emulsion as a continuous process.

25. The method of claim 18, further comprising the step of:
(f) producing said nano-emulsion as a batch process.

26. The method of claim 18, wherein said activating of said magnetostrictors is performed to produce an acoustical pressure of at least 1 kg per square centimeter in said reaction volume.

27. The method of claim 26, wherein said acoustical pressure is within a range of 1 kg per square centimeter to 4 kg per square centimeter.

28. The method of claim 18, wherein said activating of said magnetostrictors is performed to effect, within said reaction volume, a specific energy of 1.4-4.2 W/cm³, so as to efficiently produce said nano-emulsion.

29. The method of claim 18, wherein said first fluid includes water and wherein said second fluid includes a hydrocarbon.

30. The method of claim 29, wherein said second fluid is primarily diesel fuel.
